(19) United States
(12) Patent Application Publication
(10) Pub. No.: US 2002/0105886 A1
(43) Pub. Date: Aug. 8, 2002

(54) Compact disk storage

(76) Inventor: Gregory Ramonowski, Schenectady, NY (US)

Correspondence Address: HOFFMAN WARNICK & D'ALESSANDRO, LLC, 3 E-COMM SQUARE, ALBANY, NY, 12207

(21) Appl. No.: 09/777,975

(22) Filed: Feb. 6, 2001

(51) Int. Cl. G11B 33/04

(52) U.S. Cl. 369/75.1

(57) ABSTRACT

A compact disk player having a body and a play compartment to hold a first compact disk during playing of the first compact disk, the compact disk player comprising: a compact disk storage compartment, separate from the play compartment, for storing a second compact disk during non-use of the second compact disk. Also, a compact disk holder comprising: a housing having a compact disk storage compartment; and a fastener for removably attaching the housing to a compact disk player.

### BACKGROUND OF THE INVENTION

1. Technical Field

The present invention relates generally to a compact disk player and, more particularly, to compact disk holder attached to, or contained within, the body of a portable compact disk player.

2. Related Art

Portable compact disk players are favored mechanisms for listening to audio such as music while walking, running or doing any other sort of activity that requires movement. The typical compact disk player reads information from compact disks, mini disks, DataPlay disc and other forms of data storage devices. The players are typically compact and portable/hand-held.

The body of a portable compact disk player is usually made from a mold that is tooled and/or shaped to correspond to the size that is needed to encompass the elements for the electronic parts and the compact disk. The materials used to make the body of the compact disk are usually a form of polyurethane, polyethylene or the like. The body is made to be light, strong and resistant to elements like moisture, sweat and dirt.

Unfortunately, currently available compact disk players suffer from a number of disadvantages. For instance, the prior art has absolutely no means to carry more than one compact disk. This makes it impossible to have a choice of audio to listen to while utilizing the portable compact disk player and participating in the activity. As a result, it is oftentimes necessary to carry another storage unit, like a CD carrying case for an extra compact disk(s). Because many people run, jog, work or participate in other activities while utilizing portable CD players, it is inconvenient to the user to have to carry the extra case or container.

Another disadvantage of the prior art is the negative impact on battery life caused by environmental effects such as heat and cold.

Other compact disk storage systems exist for carrying compact disks and for home entertainment centers. U.S. Pat. No. 5,915,549 and U.S. Pat. No. 6,050,404 are two patents that disclose different types of CD storage containers. These compartments are in stationary pieces of furniture or are containers just for carrying extra disks. Another U.S. Pat. No. 6,009,062 is a device disclosing how to play either a mini disk or a compact disk in the same player assembly.

In view of the foregoing, there is a need in the art for a CD holder for carrying extra disks and a compact disk player including the same. It would also be advantageous if the CD holder could insulate the batteries in a CD player.

### SUMMARY OF THE INVENTION

In a first aspect of the invention is provided a compact disk player having a body and a play compartment to hold a first compact disk during playing of the first compact disk, the compact disk player comprising: a compact disk storage compartment, separate from the play compartment, for storing a second compact disk during non-use of the second compact disk. lude a foam insert for the storage compartment.

In a second aspect of the invention is provided a compact disk holder comprising: a housing having a compact disk storage compartment; and a fastener for removably attaching the housing to a compact disk player.

In a third aspect of the invention is provided a compact disk player comprising: a body for housing working components of the player; a play compartment in the body to hold a first compact disk during playing of the first compact disk; and a compact disk storage compartment, separate from the play compartment, for storing a second compact disk during non-use of the second compact disk, the storage compartment provided in a housing coupled to the player.

In a fourth aspect of the invention is provided a compact disk player comprising: a body for housing working components of the player; a play compartment in the body to hold a first compact disk during playing of the first compact disk; a compact disk storage compartment, separate from the play compartment, for storing a second compact disk during non-use of the second compact disk; and a door attached to the storage compartment for opening and closing the storage compartment.

The present invention provides a compact disk player and a compact disk holder that provide storage for a CD(s) when not in use. The CD holder can be made so that it is part of the main body of a portable compact disk player or so that it can be removed whenever the user of the portable compact disk player does not want the extra disk holder attached. In addition to the above advantages, the CD player and the CD holder unite to form a way to insulate the batteries used to power the CD player from cold or hot weather, which prolongs battery life.

The foregoing and other features and advantages of the invention will be apparent from the following more particular description of preferred embodiments of the invention.

### BRIEF DESCRIPTION OF THE DRAWINGS

The preferred embodiments of this invention will be described in detail, with reference to the following figures, wherein like designations denote like elements, and wherein:

FIG. 1 is a side view of a compact disk player with storage for a compact disk during non-use according to a preferred embodiment of the invention;

FIG. 2 is a front view of the compact disk player of FIG. 1;

FIG. 3 is a side view of a second embodiment of the invention;

FIG. 4 is a side view of a third embodiment of the invention;

FIG. 5 is a side view of a fourth embodiment of the invention;

FIG. 6 is a side view of a fifth embodiment of the invention with a storage compartment in a lid of the CD player;

FIG. 7 is a side view of the fifth embodiment of the invention with the lid closed; and

FIG. 8 is a side view of a sixth embodiment of the invention.

### DETAILED DESCRIPTION OF THE INVENTION

Referring now specifically to the drawings, there is illustrated a compact disk player 10 including a body, a play compartment for holding a first compact disk during usage of the first compact disk, and a compact disk storage compartment for storing a second compact disk during non-use of the second compact disk.

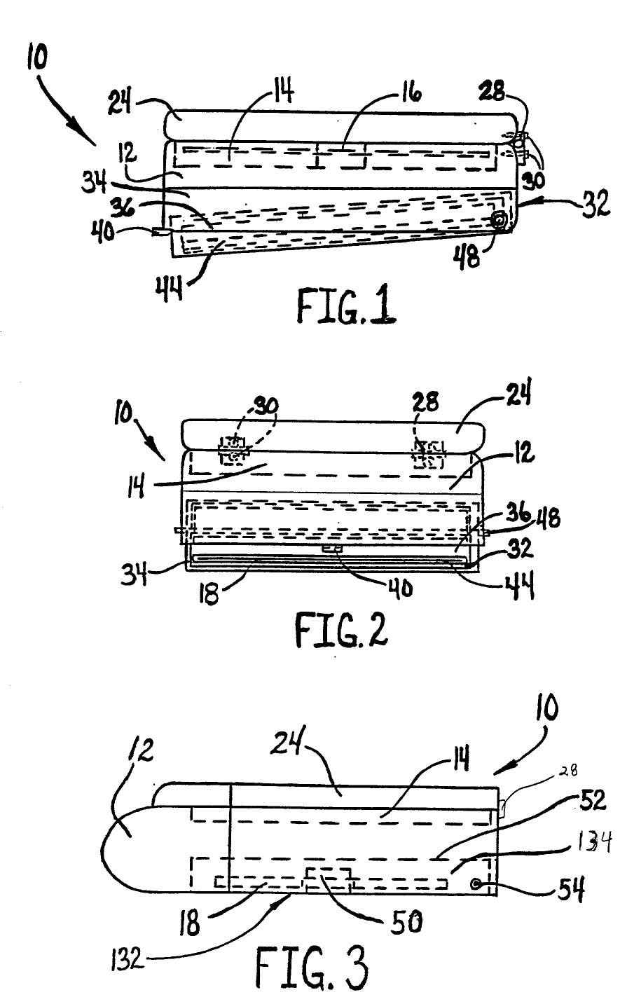

As illustrated, compact disk (CD) player 10 is preferably a portable, hand-held player. However, as will be recognized by those skilled in the art, the teachings of the invention are not be limited to just portable CD players. CD player 10 includes a body 12 for housing working components (not shown) of CD player 10 including, for example, a digital reader, batteries, electronics, etc. A play compartment 14, formed in a side of body 12, is typically provided for holding a first CD 16 (FIG. 1 only) during usage of first CD 16. A hinged door 24 may also be provided to protect CD 16 during use. As shown, door 24 is attached to body 12 by a hinged fastener 28, including a screw(s) 30 for holding door 24 to body 12. It should be recognized, however, that other door mechanisms as known in the art are also possible with the invention, e.g., a retractable door system. In accordance with the invention, CD player 10 also includes a storage compartment 32 for storing a second CD 18 (FIGS. 2 and 3 only) during non-use of second CD 18.

In a first embodiment, shown in FIGS. 1 and 2, CD storage compartment 32 is preferably provided in a housing 34 coupled to body 12 of CD player 10. Compartment 32 and housing 34, in combination, form a CD holder that is preferably provided on an opposite side of body 12 from play compartment 14. In this embodiment, the CD holder is preferably coupled to CD player 10 by fitting within the small exterior framing of CD player 10 or may be attached using small fasteners. A foam member 36 may be positioned in CD compartment 32 to protect and/or cushion second CD 18, which is preferably insertable into a slot 44 in foam member 36. In addition to cushioning second CD 18, foam member 36 also acts as an insulator to body 12 of CD player 10, which reduces enviromnental effects, e.g., cold and heat, on battery life. Of course, the type of foam used will determine the ultimate insulating effect, e.g., different foams have different R-factors. A securing tab 40 may be provided to hold housing 34 in a closed position by locking under the bottom edge of housing 34. When the securing tab 40 is released, housing 34 and, hence, storage compartment 32 is movable to an open position by pivoting housing 34 about a fixed pivot 48 that is provided in body 12.

Referring to FIG. 3, a second embodiment of the invention is disclosed. In this setting, foam 36 may be replaced by a positioning post 50. Holder 50 may be any member capable of insertion into the central opening of second CD 18. In a preferred setting, however, holder 50 is also capable of engaging the opening to hold second CD 18 in place. Also in this embodiment, it is preferable for the storage compartment 132 and housing 134 to be received in a recess 52 in body 12. Housing 134 is preferably hinged to body 12 by a pivot 54.

FIG. 4 shows a third embodiment of the invention. In this embodiment, a storage compartment 232 is formed as part of body 12, i.e., in a fixed position and without a separate housing. In this setting, compartment 232 is preferably molded into body 12. However, other mechanisms of providing compartment 232 within body 12 may also be utilized. In order to enclose compartment 232, a hinged door 56 that is movable about a pivot 58 may optionally be provided. A pull tab 60 may also be provided for ease of operation of door 56. It should be recognized that enclosure mechanisms other than a hinged door may also be possible, e.g., a sliding or retracting door.

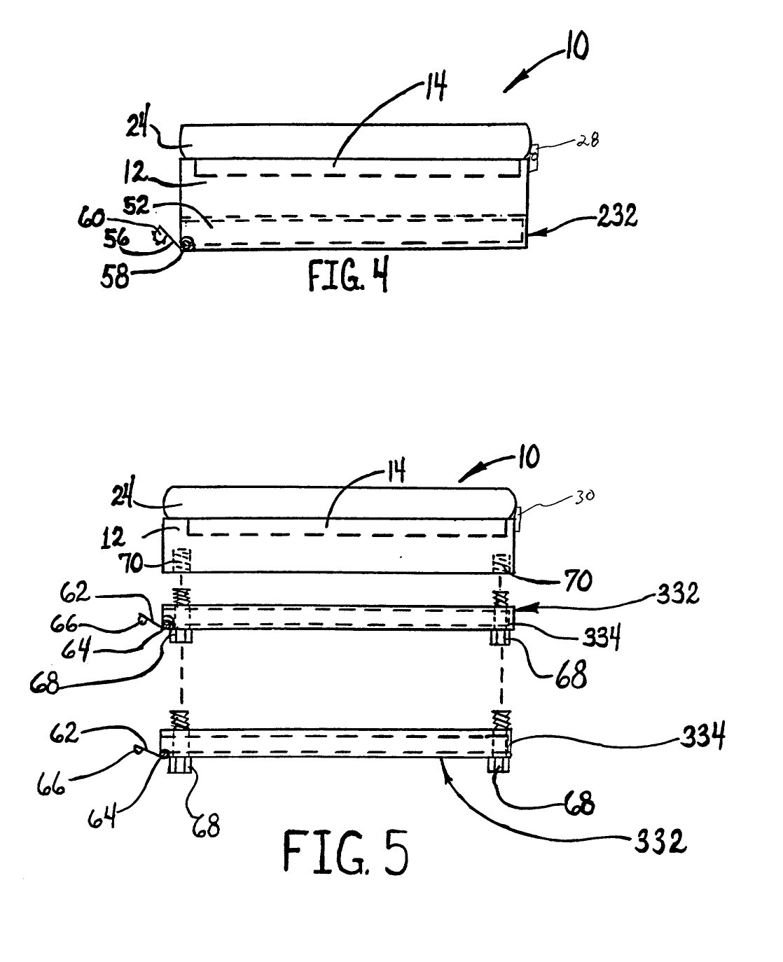

A fourth embodiment of the invention is shown in FIG. 5. In this setting, a storage compartment 332 is provided in a removably attachable housing 334. Housing 334 may include an optional hinged door 62 movable about a pivot 64 to enclose compartment 332. A pull tab 66 may be provided on the outside of the hinged door 62 for ease of operation. Again, it should be recognized that enclosure mechanisms other than a hinged door may also be possible, e.g., a sliding or retracting door. Compartment 332 is preferably secured to CD player 10 by one or more threaded fasteners 68 provided in housing 334. Fastener(s) 68 is preferably threadable into a mating threaded opening(s) 70 in body 12. Other mechanisms for connection of housing 334 to body 12 are also possible, e.g., mating male and female connectors, such as grooves, on housing 334 and body 12; adhesives; snap connectors; magnets; etc.

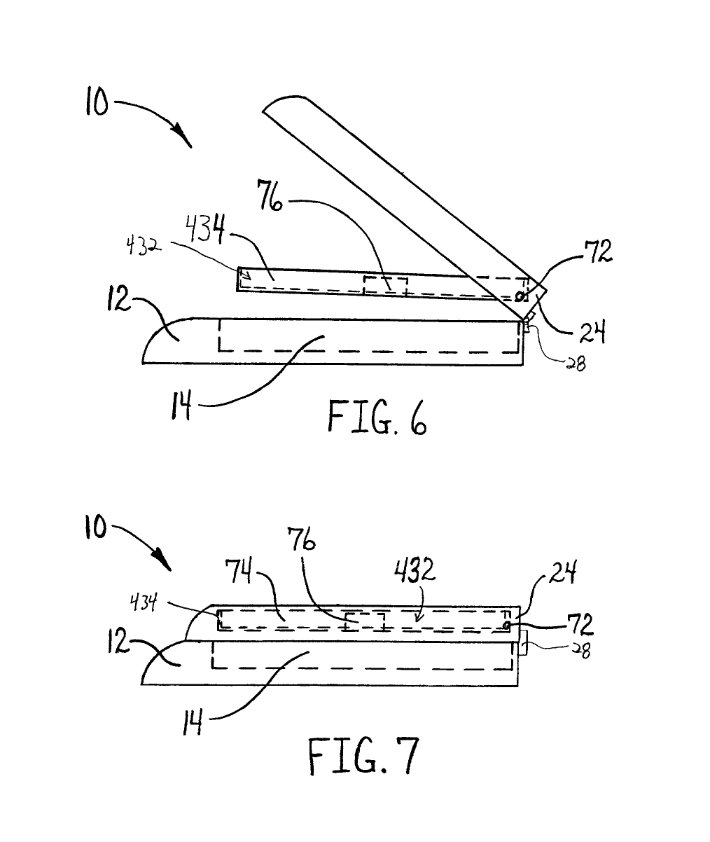

FIGS. 6 and 7 illustrate a fifth embodiment of the invention in which a storage compartment 432 is provided in lid 24 of CD player 10. Storage compartment 432 is preferably provided in a housing 434 that is received within lid 24 and pivotably attached thereto by a pivot 72. Housing 434 may also include a positioning post 76, as described above relative to the second embodiment. When lid 24 is in an open position, shown in FIG. 6, housing 434 is pivoted to a position at which storage compartment 432 is accessible. Housing 434 may be pivoted to a position within lid 24, as shown in FIG. 7, so lid 24 may be closed over play compartment 14.

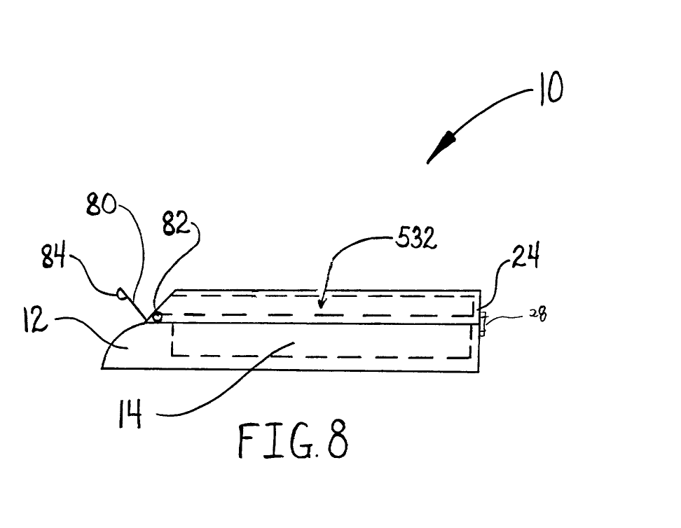

FIG. 8 shows a sixth embodiment of the invention in which a storage compartment 532 is formed as part of lid 24, i.e., without a separate housing. In this setting, compartment 532 is preferably molded into lid 24. However, other mechanisms of providing compartment 532 within lid 24 may also be utilized. In order to enclose compartment 532, a hinged door 80 that is movable about a pivot 82 may optionally be provided. A pull tab 84 may also be provided for ease of operation of door 80. It should be recognized that enclosure mechanisms other than a hinged door may also be possible, e.g., a sliding or retracting door.

In the above-described embodiments, housings 34, 134, 334, 434 are preferably made from the same material as body 12, e.g., a form of polyurethane, polyethylene or the like. Of course, other synthetic and natural materials having similar structural characteristics may also be utilized if desired.

With regard to the insulating effects of the CD holder described above, it should be recognized that those embodiments that do not provide a foam member also provide some insulating features by trapping air between body 12 and the outside. The air inside of the holder, in and of itself, helps insulate the batteries from external cold/heat.

While the present invention has been illustrated with a single CD holding compartment, it should be recognized that the storage compartment may be sized to include more than one CD. Further, more than one CD holder may be coupled to the body of the CD player, e.g., stacked compartments 332. For example, as shown in FIG. 5, additional storage compartments 332 may be added by having threaded fasteners 68 with heads capable of receiving further threaded fasteners therein. Other mechanisms for coupling CD holders together may also be used, e.g., mating male and female connectors, such as grooves; adhesives; snap connectors; magnets; etc.

The foregoing description of the preferred embodiments of the invention has been presented for the purposes of illustration and description. It is not intended to be exhaustive or to limit the invention to the precise form disclosed, and obviously many modifications and variations are possible in light of the above teaching. Such modifications and variations that may be apparent to a person skilled in the art are intended to be included within the scope of this invention as defined by the accompanying claims.

I claim:

1. A compact disk player having a body and a play compartment to hold a first compact disk during playing of the first compact disk, the compact disk player comprising:
a compact disk storage compartment, separate from the play compartment, for storing a second compact disk during non-use of the second compact disk.

2. The compact disk player of claim 1, wherein the storage compartment is provided in a housing that is hinged to the body.

3. The compact disk player of claim 2, wherein the housing is positionable in a recess of the body when in a closed position.

4. The compact disk player of claim 2, wherein the storage compartment includes a positioning post for the second compact disk.

5. The compact disk player of claim 2, wherein the storage compartment includes a foam member therein.

6. The compact disk player of claim 1, wherein the storage compartment is provided in a housing that is removably attached to the body.

7. The compact disk player of claim 1, wherein the storage compartment is contained within the body, and further comprising a door attached for opening and closing the storage compartment.

8. The compact disk player of claim 1, wherein the storage compartment is positioned on a side opposite the body from the play compartment.

9. The compact disk player of claim 1, wherein the storage compartment is provided in a lid of the play compartment.

10. The compact disk player of claim 1, further comprising a plurality of storage compartments coupled to the body.

11. A compact disk holder comprising:
a housing having a compact disk storage compartment; and
a fastener for removably attaching the housing to a compact disk player.

12. The compact disk holder of claim 11, wherein the fastener is a hinge.

13. The compact disk holder of claim 11, wherein the housing is positionable in a recess of the compact disk player.

14. The compact disk player of claim 11, wherein the storage compartment includes a foam member having a slot for receiving a compact disk.

15. The compact disk holder of claim 11, wherein the storage compartment includes a compact disk positioning post.

16. A compact disk player comprising:
a body for housing working components of the player;
a play compartment in the body to hold a first compact disk during playing of the first compact disk; and
a compact disk storage compartment, separate from the play compartment, for storing a second compact disk during non-use of the second compact disk, the storage compartment provided in a housing coupled to the player.

17. The compact disk player of claim 16, wherein the housing is hinged to the body.

18. The compact disk player of claim 16, wherein the storage compartment includes a positioning post for the second compact disk.

19. The compact disk player of claim 16, wherein the storage compartment includes a foam member therein.

20. The compact disk player of claim 16, wherein the housing is hinged to a lid of the play compartment.

21. The compact disk player of claim 16, wherein the storage compartment is positioned on a side opposite the body from the play compartment.

22. A compact disk player comprising:
a body for housing working components of the player;
a play compartment in the body to hold a first compact disk during playing of the first compact disk;
a compact disk storage compartment, separate from the play compartment, for storing a second compact disk during non-use of the second compact disk; and
a door attached to the storage compartment for opening and closing the storage compartment.

23. The compact disk player of claim 22, wherein the storage compartment is located in a lid for the play compartment.
